(19) United States
(12) Patent Application Publication
(10) Pub. No.: US 2006/0217939 A1
(43) Pub. Date: Sep. 28, 2006

(54) Time series analysis system, time series analysis method, and time series analysis program

(75) Inventors: Takayuki Nakata, Tokyo (JP); Junichi Takeuchi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/389,086

(22) Filed: Mar. 27, 2006

(30) Foreign Application Priority Data
Mar. 28, 2005 (JP) 2005-091174

(51) Int. Cl. G06F 15/00

(52) U.S. Cl. 702/189

(57) ABSTRACT

A time series analysis system can perform computation with a less amount of computation than before when a long-term trend component and a long-term cyclic component are handled, or when a plurality of cyclic components is handled. From input time series data including a plurality of cyclic components, long-term time series data of a different series using a plurality of time spans is prepared for each of the time spans. Then, the long-term time series data for each of the time spans is removed from the original time series data, thereby preparing short-term time series data. Then, by learning through probability statistic processing that uses the long-term time series data and the short-term time series data, a model having a time span optimal for prediction of the time series data is selected as an optimal model, and is used for prediction of the time series data.

### FIELD OF THE INVENTION

The present invention relates to a time series analysis system, a time series analysis method, and a time series analysis program. More specifically, the invention relates to a time series analysis system, a time series analysis method, and a time series analysis program that can estimate a time series component at a high speed and with a high degree of accuracy when time series data includes a long-term trend component or a long-term cyclic component and when the time series data is multivariate.

### BACKGROUND OF THE INVENTION

Some methods for capturing characteristics of time series data including trend and cyclic components, separating and extracting each of the components, and estimating future trends based on a result of analysis thereof have been hitherto proposed in a field of time series analysis.

One example of a time series analysis method that uses a statistical approach is described in Nonpatent Document 1. In this system, original time series data that has been observed and respective time series components such as the trend component, cyclic component, and an AR (Auto Regressive, or Auto Regression) component that are included in this data series, are expressed in a form referred to as a state space representation. By applying computing unit called a Kalman filter to this state space representation, the respective components of the original time series data are separated and extracted.

[Nonpatent Document 1] Tohru Ozaki, Genshiro Kitagawa: Statistical Method of Time Series Analysis, Asakura Publishing Company, P. 93-106, 1998.

[Nonpatent Document 2] J. Rissanen: Universal coding, information, prediction and estimation, IEEE Transactions on Information Theory, Vol. IT-30, p. 629-636, 1984.

[Nonpatent Document 3] Z. Ghahramani and G. E. Hinton: Parameter Estimation for Linear Dynamical Systems, Technical Report CRG-TR-96-2, University of Toronto, 1996.

[Nonpatent Document 4] K. Yamanishi, J. Takeuchi, G. Williams and P. Milne: On-line Unsupervised Oultilier Detection Using Finite Mixtures with Discounting Learning Algorithms, Data Mining and Knowleged Discovery Journal, 8(3): 275-300, May 2004.

The disclosure of the above documents are incorporated herein by reference thereto also with respect to the present invention as part thereof.

### SUMMARY OF THE DISCLOSURE

These methods have been hitherto applied to economy and natural phenomena. Thus, one record was often measured in days and months. As a result, a time series including only one cyclic component having a comparatively short cycle length such as seven days or 12 months was often handled. Further, in most cases, one-dimensional data was handled, and data of several dimensions at most was handled.

In recent years, it has become possible to obtain a large quantity of time series data from an information system that uses a computer or a network device or a traffic system in which a sensor is mounted on a road or a vehicle, at a shorter time interval (with one record being five minutes to one hour). For this reason, when the conventional approaches are used without alteration, the following problem will occur.

A first problem is that an amount of computation will become extremely large when the long-term trend component and the long-term cyclic component are handled or when a plurality of cyclic components are handled. When the time series data is handled using the state space representation, the amount of computation becomes of the order of cube (third power) of the sum of the orders of the trend components and the cyclic components included therein.

Conventionally, when one cycle of seven days with each day used as one record was handled, the amount of computation was of the order of cube of the order seven of the cyclic components. However, when one cycle of 24 hours with each five minutes used as one record is handled, the order of the cyclic components becomes 288 (=12×24), and the amount of computation becomes of the order of cube of 288. When data having a length of several weeks or longer is handled with each hour used as one record, it is necessary to consider a plurality of cycles, i.e., at least the cycle of 24 hours and the cycle of seven days. On this occasion, it is necessary to handle the orders of the respective cyclic components of 24 and 168 (=24×7). When the state space representation is used, the amount of computation becomes of the order of cube of the sum of the orders of the respective cyclic components of 192 (=24+168).

A second problem is that since the conventional approaches basically assume one-cycle-ahead prediction, sufficient accuracy cannot be obtained at a time of long-period-ahead prediction. When the long-period-ahead prediction is performed using the conventional approaches, the approaches of repetitively applying just one-period-ahead prediction are often employed.

When the prediction about a future long period of several days to several weeks is performed with one hour used as one record, it is necessary to perform a lot of one-hour-ahead prediction with the conventional approaches. When one-week-ahead prediction is performed, for example, the one-hour-ahead prediction needs to be performed 168 (=24×7) times. In this case, characteristics of the trend component and the cyclic component are computed based on variations per each hour. Thus, when a value after a long time is predicted based on these, the value will be influenced by fine variation or noise. Thus, sufficient prediction accuracy cannot be obtained.

A third problem is that the amount of computation will become extremely large when a multivariate time series is handled. Much more time series data than before can be obtained. Thus, it often happens that time series data of 10 series or more is handled simultaneously in an actual application. When the multivariate time series data is handled using the state space representation, the amount of computation thereof becomes of the order of cube of the sum of the orders of the respective time series data. When the number of the time series data is ten and each of the time series data has the order of 24, the amount of computation becomes of the order of cube of 240 (24×10), which is the sum of the orders of the respective time series data.

Accordingly, it is an object of the present invention to provide a time series analysis system that can perform computation with a less amount of computation than conventional when long-term trend and cyclic components are handled, or when a plurality of cyclic components are handled. It is another object of the present invention to provide a time series analysis system that can obtain a result with a higher accuracy than conventional when the long-time-ahead prediction is performed. It is a further object of the present invention to provide a time series analysis system that can perform computation with a less amount of computation than conventional when a multivariate time series is handled.

According to a first aspect of the present invention, there is provided a time series analysis system for inputting time series data including a plurality of cyclic components, storing the time series data in a storage unit, and predicting a temporal tendency of the time series data, the time series analysis system comprising:

long-term time series setting unit of preparing long-term time series data of a different series using a plurality of time spans for each of the time spans, based on the input time series data and the time series data read from the storage unit and storing the resultant long-term time series data in the storage unit;

long-term time series removing unit of removing the long-term time series data for the each of the time spans from the input time series data, by preparing short-term time series data corresponding to the removed long-term time series data for the each of the time spans, and storing the resultant short-term time series data in the storage unit; and

optimal model selection unit of selecting a model having a time span optimal for prediction of the time series data based on learning through probability statistic processing using the long-term time series data and the short-term time series data both stored in the storage unit.

According to a second aspect of the present invention, a time series analysis system comprises:

long-term time series setting unit of performing setting for expressing a long-term series component of time series data including a long-term trend component and a long-term cyclic component, using an approach capturing an overall variation characteristic and using a small amount of computation, the long-term trend component and the long-term cyclic component constituting the long-term series component;

long-term time series storage unit of storing a result of learning of the long-term time series component;

short-term time series setting unit including a long-term time series removing unit for removing this long-term time series component from the original time series data and a short-term time series setting unit for inputting time series data with the long-term time series component removed therefrom and setting a short-term time series component;

short-term time series storage unit of storing a result of learning the short-term time series component;

optical model selection unit of selecting an optical model based on an information amount criterion computed by probability statistic processing when a plurality of expressions of the long-term time series component are present;

time series prediction unit of predicting a future value of the time series data based on the time series model and the time series data; and

time series model learning unit of learning the time series model form the time series data and estimating a parameter.

By using such a configuration, expressing the long-term cyclic component employing an approach that uses a small amount of computation, and optimizing a manner of the expression using the information amount criterion, the objects of the present invention can be achieved.

According to a further aspect of the present invention, there is provided a time series analysis system comprising:

a learning object component selection unit of extracting only a combination or combinations of partial components among components included in time series components; and

a partial model leaning unit of performing learning of only a combination or combinations of the components selected.

By adopting such a configuration, and repeating a process of selecting only a combination or combinations of the targeted components among the components included in the time series data and performing parameter leaning, the objects of the present invention can be achieved.

The meritorious effects of the present invention are summarized as follows.

A first effect is that the amount of computation can be greatly reduced when the long-term trend component and the long-term cycling component are included. As a result, the time required for data analysis can be reduced. The reason for this is that the long-term trend components and the long-term cyclic components that require a large amount of computation when they are handled are hierarchically separated and processed employing an approach that uses a small amount of computation.

A second effect is that accuracy of long-term prediction can be improved. The reason for this is that a plurality of models are conceived as an approach to expressing the long-term time series component and the optimal one of the models is selected based on the information amount criterion.

A third effect is that the amount of computation can be greatly reduced when multivariate time series data is handled. The reason for this is that by learning only a combination or combinations of partial components included in the original multivariate time series data, parameter estimation is performed using a smaller amount of computation.

### BRIEF DESCRIPTION OF THE DRAWINGS

FIG. 1 is a block diagram showing a configuration of a first embodiment of the present invention;

FIG. 2 is a flowchart showing a general operation of the first embodiment of the present invention;

FIG. 3 is a flowchart showing operations up to prediction using a model in the first embodiment of the present invention; and

FIG. 4 is a flowchart showing an operation of prediction of a time series in the first embodiment of the present invention.

### PREFERRED EMBODIMENTS OF THE INVENTION

Next, embodiments of the invention will be described in detail with reference to drawings.

### First Embodiment

In this embodiment, an optimal model for prediction of a time series will be learned and estimated from time series data having an appropriate time span (or interval). Then, a predicted value of time series data at a point just after predetermined time span is predicted based on the estimated model and output. That is, a time series analysis method of the invention can be divided into two stages: one stage up to estimation of the optimal model and the other stage of prediction of the time series using the model for prediction.

Incidentally, the model used for the prediction of the time series may be appropriately learned and estimated at a regular timing or an irregular timing, and may be dynamically changed.

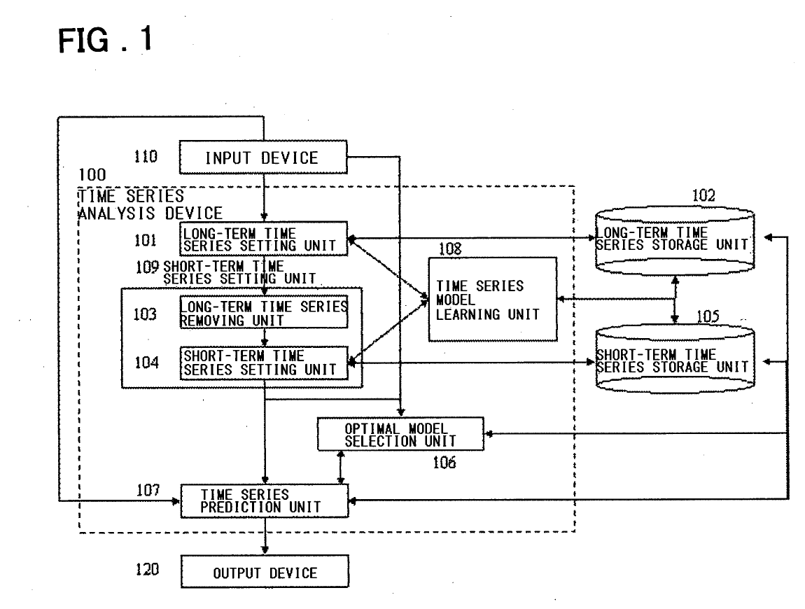

Referring to FIG. 1 that shows a configuration according to a first embodiment of the present invention, the first embodiment of the present invention is constituted from a time series analysis device 100 that is operated by program control, an input device 110, and an output device 120. The time series analysis device 100 includes a short-term time series setting unit 109 having a long-term time series removing unit 103 and a short-term time series setting unit 104, long-term time series setting unit 101, long-term time series storage unit 102, short-term time series storage unit 105, optimal model selection unit 106, time series prediction unit 107, and time series model leaning unit 108. These units generally operate as follows, respectively.

The input device 110 is the device to which time series data is input. The output device 120 is the device for outputting a result of processing by the time series analysis device 100.

The long-term time series setting unit 101 inputs time series data and stores the time series data, a parameter for a time series model of a long term time series component, and a result of learning such as a conditional probability distribution etc., in the long-term time series storage unit 102.

The short-term time series setting unit 109 uses the long-term time series removing unit 103 and the short-term time series setting unit 104, thereby generating and storing short-term time series data. More specifically, the long-term time series removing unit 103 is the unit for removing the long-term time series component from the original time series data. The short-term time series setting unit 104 inputs the time series data with the long-term time series component removed therefrom by the long-term time series removing unit 103 and stores a result of learning of a short-term time series component in the short-term time series storage unit 105.

The optimal model selection unit 106 is a unit for selecting the model optimal for the time series prediction from a plurality of time series models based on an information amount criterion referred to as predictive, probabilistic complexity.

The time series prediction unit 107 is a unit for predicting a future value from the time series model and the time series data.

The time series model leaning unit 108 is a unit for leaning the time series model from the time series data and estimating the parameter.

As the units for storing the time series data and the like, the two units of the long-term time series storage unit 102 and the short-term time series storage unit 105 are used. These storage units may be combined into one unit, however, and may also be the storage unit that is more finely divided for each data to be stored.

1. Optimal Model Estimation

(1) Rough Concept

First, estimation of the optimal model will be described. It is assumed hereinafter that an observed value at a point n is indicated by xₙ and an observed value series x₁ to xₘ (in which 1≦m) is indicated by x₁^{m}. Herein, each value xₙ is assumed to be the value of a real number, while n is assumed to be an integer. For simplicity of description, the observed value is described to be one dimensional. The observed value may be, however, multidimensional. Further, it is especially assumed that xⁿ=x₁ⁿ. It is assumed that such time series data xₙ is input from the input device 110. At this point, the time series data xₙ is constituted from a long-term cyclic component s_{1,n}, a short-term cyclic component s_{2,n}, and an AR component νₙ. It is assumed that the time series data xₙ can be expressed as follows:
xₙ=s_{1,n}+s_{2,n}+νₙ+εₙ (Equation 1)

More generally, the time series data xₙ may include a trend component. Herein, however, for simplicity of the description, the trend component is excluded. The manner of the description is not essentially changed from the manner of description of the cyclic components (refer to Nonpatent Document 1, for example, the entire disclosure thereof being herein incorporated by reference thereto) that will be described below. Herein, εₙ is assumed to be a term for noise and to be an independent and identical distribution that follows a normal distribution N(0, σ²). In this case, each cyclic component can be modeled as follows:
s_{1,n}=−s_{1,n-1}− . . . −s_{1,n-L}_{₁}₊₁+ω_{1,n} (Equation 2)
s_{2,n}=−s_{2,n-1}− . . . −s_{2,n-L}_{₂}₊₁+ω_{2,n} (Equation 3)

The AR component can be modeled as follows:

$${v}_{n} = {\sum }_{i = 1}^{p} {a}_{i} {v}_{n - i} + {ω}_{3 , n} \qquad ( Equation 4 )$$

where L₁ and L₂ are integers each indicating a cycle length of each cyclic component. When one record is set to one hour, and when two cycles of seven days and 24 hours are present, the cycle lengths of the cyclic components will become L₁=168 (=24×7) and L₂=24. aᵢ is referred to as an AR coefficient, and p is referred to as the order of the AR model. ω_{1,n}ω_{2,n}, and ω_{3,n} are assumed to be noise terms and to be independent and identical distributions that follow normal distributions N(0, τ₁²), N(0, τ₂²), and N(0, τ₃²), respectively.

As a method of obtaining the respective components s_{1,n}, s_{2,n}, and vₙ from the observed value xₙ, the method of expressing the equations 1 to 4 described before using a state space expression and estimating the components using a Kalman filter may be conceived (refer to Nonpatent Document 1, for example). When a state vector term and the noise term expressed using s_{1,n}, s_{2,n}, and vₙ are set, respectively, as follows,
zₙ=[s_{1,n}s_{1,n-1}, . . . , s_{1,n-L}_{₁}₊₂s_{2,n}s_{2,n-1}, . . . , s_{2,n-L}_{₂}₊₂,νₙ,νₙ₋₁, . . . , νₙ₋ₚ₊₁]^{T} (Equation 5)
ω_{n=[ω}_{1,n},0, . . . ,0,ω_{2,n},0, . . . ,0, ω_{3,n}, 0, . . . ,0]^{T} (Equation 6)
the vector and the term can be expressed as follows, using the state space representation:
zₙ=Fzₙ₋₁+ωₙ (Equation 7)
xₙ=Hz_{n+ε}ₙ (Equation 8)
where F, ωₙ, and H are matrixes of (L₁+L₂+p−2)×(L₁+L₂+p−2), (L₁+L₂+p−2)×1, 1×(L₁+L₂+p−2), respectively. A notation T represents a matrix arrangement used commonly in a mathematical notation. When the Kalman filter is used for learning of these state space representations, the amount of computations will approximate 0((L₁+L₂)³) because these representations include inverse matrix computation. The order p of the AR model is, however, set to be sufficiently smaller than the cycle lengths L₁ and L₂.

Then, in this embodiment, the learning is divided into two steps constituted from the step of learning the time series data with a long-term cycle and the step of leaning the time series data with a short-term cycle. Reduction of the amount of computation is thereby achieved.

First, among the cycles included in the original input observed value series xₙ, only the long-term cycle s_{1,n} is obtained by the long-term time series setting unit 101. In order to prepare a long-term time series, time series data ξₖ based on a data interval τ is newly set as follows:

$${ξ}_{k} = \frac{1}{τ} {\sum }_{n = τ ( k - 1 ) + 1}^{τκ} {x}_{n} \qquad ( Equation 9 )$$

In this case, a submultiple of the cycle length L₁ of the long-term cycle, such as τ=2, 3, 4, 6, . . . when L₁=168 can be designated as the data interval τ. According to the manner of the designation, a plurality of different time series models are prepared. Hereinafter, a model when the data interval τ is set to the mth submultiple of the cycle length L₁ of the long-term cyclic component of two or larger will be expressed as a “model m”. A group of the mth submultiples of the cycle length L₁ of the long-term cyclic component of two or more will be expressed as M, and the number of elements in the group will be expressed as |M|. Then, the following learning is performed on the model for each element in the group M.

The time series ξₖ indicating this long-term cycle (hereinafter referred to as long-term time series data) is removed from the original time series data xₙ by the long-term time series removing unit 103. Assume that time series data after the long-term time series data ξₖ has been removed from the time series data xₙ is set to data uₙ (hereinafter referred to as “short-term time series data”).

Then, the data Un can be written as follows:
uₙ=xₙ−ξₖ (Equation 10)

In this case, this equation holds true for a relation of τ(k−1)+1≦n≦τk. From this time series data, the long-term cyclic component has been already removed, and the time series data includes only the short-term cyclic component. Thus, by modifying Equation 1 as follows,
uₙ=s_{2,n}+νₙ+εₙ (Equation 11)

learning of the time series model in a normal time series analysis is performed using the time series model leaning unit 108, and the short-term cyclic component can be estimated.

At the same time, the long-term time series data is assumed to follow another time series model expressed as follows:
ξₖ=s_{3,k}+ν_{2,k}+ε_{2,k} (Equation 11-2)

In this model, the order of the cyclic component becomes L₁/τ. Accordingly, the amount of computation for both of the components becomes 0(L₁/τ)³+L₂³). Thus, compared with the amount of computation 0(L₁+L₂)³) when the long-term cyclic component has not been removed, it can be seen that the amount of the computation can be greatly reduced.

Though an approach to applying the state space model to the long-term time series data each obtained by taking an average value of the original time series data at an interval τ is herein shown, other approaches may be employed. As one of the other approaches, the approach to representing the long-term time series component using a polynomial regression model, for example, may be conceived. When the polynomial regression model is used, the observed value series can be expressed as xₙ=ξₙ+δₙ, which is the sum of a polynomial value ξₙ and a noise term δₙ. The noise term δₙ is, however, assumed to follow the independent identical distribution expressed by the normal distribution N(0, σ²) Further, the value ξₙ is assumed to be expressed by ξₙ=b₀+b₁ₙ+ . . . +b _{τ}_{ⁿ}^{τ}. This polynomial is considered to indicate a long-term tendency in the original data series when the order thereof is limited to be low. Though the independent identical distribution is assumed for the noise term, it is natural that this noise term should be treated as a short-term series indicating a short-term tendency. That is, an expression of uₙ=xₙ−ξₙ is defined as the short-term series and analyzed by application of the state space model. Alternatively, by changing a manner in which the order τ of the polynomial model is specified, a plurality of long-term series components can be prepared and can be removed from the original observed value series.

As one of the other approaches, the approach that uses Fourier analysis, for example, may be conceived. When the Fourier analysis is used, the observed value series can be expressed in the form of the sum of trigonometric functions as follows:
xₙ=a₀+Σₛ₌₁^{τ}(aₛ cos(2πs/T)n+bₛ sin(2πs/T)n)+δₙ (Equation 11-3)

in which T is the cycle. In this case as well, by changing the manner in which the order τ is specified, and approximating the original time series data, the long-term time series component can be prepared and removed, whereby the same effect as that when the average value is employed can be obtained. The same approach can be implemented by using Wavelet analysis as well. More generally, when a normal orthogonal system |e τ| is employed, expression such as xₙ=Στ=0^{∝}c_{τ}e_{τ} can be performed. In this case as well, by performing the same operation as that described before, the same effect as that when the average value is employed can be obtained.

In either case, a probability distribution followed by the long-term time series data is specified by the finite number of parameters (in the case of polynomial regression, for example, bⱼ (j=0, 1, . . . , τ) and a distribution parameter for the noise term). Hereinafter, as the model followed by the long-term time series data ξₖ (ξₙ in the case of the polynomial regression model), the model with an order m is employed. This is expressed by a probability density function q (ξₖ|ξ^{k-1}, φₘ, m) of the data ξₖ under a condition in which data ξ^{k-1} has been given. φₘ is a vector representation of the parameter. Likewise, F the model for the short-term time series data is expressed by r(uₙ|uⁿ⁻¹, ψₘ, m). Likewise, when the model for the observed value series xₙ is written as P(xₙ|xⁿ⁻¹, θₘ, m)(where θₘ=( θₘ, ψ m), the following relation holds:
P(xₙ₊ᵢ₋₁|xⁿ⁻¹,θₘ,m)=∫r(xₙ₊ᵢ₋₁−ξₖ₊ⱼ|uⁿ⁻¹,ψₘ,m)q(ξₖ₊ⱼ|ξ^{k},φₘ,m)dξₖ₊ⱼ (Equation 11-4)

This holds when j≧1 and τ(k+j−1)+1≦n+i−1≦τ(k+j). Further, when i≧1, the value of a left side is obtained using:
P(xₕ₊ᵢ₋₁|x^{h-1},θₘ,m)=∫P(xₕ^{h+i-1}|x^{h-1},θₘ,m)dxₕ^{h+i-2} (Equation 11-5)
P(xₕ^{h+i-1}|x^{h-1},θₘ,m)=Πⱼ₌₀ⁱ⁻¹P(xₕ₊ⱼ|x^{h-1+j},θₘ,m) (Equation 11-6)

(in the case of the state space model, the value can be easily computed by computation in regard to i-cycle-ahead prediction using Karman filter). The values of r and q of a right side are also obtained in the same manner. When r(uₙ₊ᵢ₋₁|uⁿ⁻¹, ψₘ, m) and q(ξₖ₊ⱼ|ξ^{k}, φ m, m) are density functions of normal distributions N(μ1, σ1²) and N(μ2, σ2²), respectively, in particular, it is noted that P(xₙ₊ᵢ₋₁|xⁿ⁻¹, θₘ, m) becomes the density function of a normal distribution N(μ1+μ2, τ1²+σ2²). When j=0, the following relation simply holds:
P(xₙ₊₁₋₁|xⁿ⁻¹,θₘ,m)=r(xₙ₊ᵢ₋₁−ξₖ|uⁿ⁻¹,ψₘ,m) (Equation 11-7)
(where τ(k−1)+1≦n+i−1≦τk). In the case of the polynomial regression or the like, it should be considered in the above equation that τ is equal to one, and n is equal to k, (however, the order of the polynomial expression or the like is left without alteration).

When learning using the model m is performed on time series data xⁿ⁻¹ by using the above processing (learning and estimation after Equations 9 to 11 have been modified), a parameter θₘ (xⁿ⁻¹) and a conditional probability density function P(xₙ|xⁿ⁻¹, θₘ(xⁿ⁻¹), m) for the time series model are obtained.

By using this conditional probability density function, when x^{N} (=x₁, x₂, . . . , x_{N}) is obtained, the following value for each model m is computed by the optimal model selection unit 106.

$$I ( {x}^{N} \text{:} m ) = {\sum }_{n = 1}^{N - t + 1} ( - log P ( {x}_{n + t - 1} \vert {x}^{n - 1} , {θ}_{m} ( {x}^{n - 1} ) , m ) ) \qquad ( Equation 12 )$$

provided that
P(xₕ₊ᵢ₋₁|x^{h-1},θₘ(x^{h-1}),m)=∫P(xₕ^{h+i-1}|x^{h-1},θₘ(x^{h-1}),m)dxₕ^{h+i-2} (Equation 12-2)
P(xₕ^{h+i-1}|x^{h-1},θₘ(x^{h-1}),m)=Πⱼ₌₀ⁱ⁻¹P(xₕ₊ⱼ|x^{h-1+j},θₘ(x^{h-1}),m) (Equation 12-3)

This value is an amount referred to as the predictive, probabilistic complexity (refer to Nonpatent Document 2, for example, the disclosure thereof being incorporated herein by reference thereto). The predictive, probabilistic complexities for the respective models are compared, and the model with the minimum predictive, probabilistic complexity is adopted as the optimal model. The parameter i in Equation 12 means that the optimal model for the predicted value after i cycles is adopted. Incidentally, the predictive, probabilistic complexity can be replaced by other information amount criterion that can become a comparable index.

(2) Sequential Computation Using EM Algorithm and Karman Filter

When the predictive, probabilistic complexity is computed, the parameter θₘ(xⁿ⁻¹) for the time series model is first computed from the observed value series xⁿ⁻¹. When the observed value xₙ is newly obtained and a parameter θ m(xⁿ) for the time series model is computed from observed value series xⁿ, a computation cost will be very high when the common Karman filter is used and the learning is performed again from the beginning thereof. In order to solve this problem, an approach to sequentially learning the model and updating the parameter when a new observed value is obtained can be used (refer to a description associated with Nonpatent Document 4 that will be described later, the disclosure thereof being incorporated herein by reference thereto).

When the parameter is estimated using the Karman filer, an approach for numerical maximization such as a hill-climbing method is often employed. A sequential version of an EM algorithm, which is the algorithm for estimating a statistical model having a hidden variable is herein employed (refer to Nonpatent Document 3, for example, the disclosure thereof being incorporated herein by reference thereto).

The EM algorithm is the algorithm for maximizing a conditional expected value of a logarithmic likelihood for each repetition of iterative computation. A parameter when the conditional expected value of the logarithmic likelihood is maximized is computed using the conditional expected value of a sufficient statistic. In the following example, in order to perform sequential learning, an algorithm is used which computes the conditional expected value of the sufficient statistic weighted by an oblivion coefficient γ while sequentially inputting data at a time of updating the parameter. That is, the sum of the conditional expected value of the sufficient statistic of the current data xₙ weighted by the coefficient γ and the conditional expected value of the sufficient statistic of the past data x_{z}ⁿ⁻¹ weighted by a coefficient (1-γ) is set to the conditional expected value of the weighted sufficient statistic of whole data xⁿ. When the coefficient γ is set to be equal to 1/n with g being dependent on n, all the data can be equally weighted, and sequential leaning can be performed (refer to Nonpatent Document 4).

A procedure when the sequential learning is performed while preparing and removing the long-term time series component will be described. As in the example described before, the observed value series is expressed as xₙ, and the new time series data ξₖ based on the new data interval τ is defined as follows:

$${ξ}_{k} = \frac{1}{τ} {\sum }_{n = τ ( k - 1 ) + 1}^{τ k} {x}_{n} \qquad ( Equation 13 )$$

When the observed series xₙ is given, the new observed value series ξₖ is obtained whenever n reaches τk. Since the value of the long-term cyclic component τₖ is obtained, the long-term cyclic component τₖ is removed from the original time series xₙ by the long-term time series removing unit 103. When the time series data after removal of the long-term cyclic component is set to uₙ, the following equation holds:
uₙ=xₙ−ξₖ (Equation 14)
provided that this equation applies when τ(k−1)+1≦n≦τk.

An example in which the state space representation of this short-term time series data uₙ is set to as follows,
yₙ=F′yₙ₋₁+ω′ₙ (Equation 15)
uₙ=H′yₙ+ε′ₙ (Equation 16)

and the parameter is estimated using the EM algorithm will be described below. By using the same procedure as that for the long-term time series data as well, parameter estimation can be performed.

Now, a Qn function in an E step in a situation where the observed value series uₙ is given will be defined as follows. q(yₙ,uₙ|uⁿ⁻¹, ψ m(uⁿ⁻¹)) indicates a simultaneous probabilistic density function for yₙ and uₙ determined by Equations 15 and 16. Further, Q₀(ψₘ) is set to one.
Qₙ(ψₘ)=(1−γ)Qₙ₋₁(ψₘ)+γE_{θ}_{ₘ}└log q(yₙ,uₙ|uⁿ⁻¹,ψₘ(uⁿ⁻¹))|uₙ,uⁿ⁻¹┘ (Equation 17)

where γ is the oblivion coefficient that is larger than zero but smaller than one. Estimation of a state in the E step can be computed by using the Karman filter as with the common EM algorithm. Next, for Qₙ(ψ m′), the following is computed:

$${ψ}_{m} ( {u}^{n} ) = arg {max}_{{ψ}_{m}} {Q}_{n} ( {ψ}_{m} ) \qquad ( Equation 18 )$$

In this M step, the value of a parameter ψₘ(uⁿ)=(F′, H′, Q′, R′) of this system is obtained. Q′ and R′ are covariance matrixes of ω n′, ε n′, respectively. By weighting an old statistic by (1−γ) and weighting a newly obtained statistic by γ, and by updating the parameter of the system using the sum of these weighted statistics, the sequential learning is implemented. Generally, a region that is proportional to the number n becomes necessary for storage of the function Qn. In the state space model, by using the sufficient statistic, description with a description length that does not depend on n is possible. In the example described above, a case where the parameter is updated using one data uₙ at a time was described. It is easy to generalize this for each R pieces of data (where R is equal to or larger than one).

(3) Computation of Predictive, Probabilistic Complexities

When (Equation 11-4) and (Equation 11-7) are used to obtain the value of P(xₙ₊ᵢ₋₁|xⁿ⁻¹, θ m(xⁿ⁻¹, m), the predictive, probabilistic complexities can be computed.

2. Prediction of Time series Using Learned Model

After the model used for the prediction has been adopted based on comparison of the predictive, probabilistic complexities, time series data after a predetermined time span is predicted, using this model, each time series data is given. Herein, the state space model is adopted. Thus, parameter adjustment is made using the EM algorithm and Karman filter shown above. Using the learned result P(xₙ₊ᵢ₋₁|xⁿ⁻¹, θ m(xⁿ⁻¹), m), a predictive value x′ₙ₊ᵢ₋₁ of data xₙ₊ᵢ₋₁ is computed through the use of a normal expected value ∫xₙ₊ᵢ₋₁P(xₙ₊ᵢ₋₁|xⁿ⁻¹, θ m(xⁿ⁻¹), m)dxₙ₊ᵢ₋₁.

In the case of the state space model, γ (uₙ₊ᵢ₋₁|uⁿ⁻¹, ωₘ, m) and q(ξₖ₊ⱼ|ξ^{k}, Φₘ,m) are normal distributions. When these are expressed by N(μ₁, σ₁²) and N(μ₂, σ₂²), P(xₙ₊ᵢ₋₁|xⁿ⁻¹, m) becomes the density function of a normal distribution N(μ₁+μ₂, σ₁²+σ₂²), as described before. Thus, when the predicted value (expected value) of uₙ₊ᵢ₋₁ is written as u′ₙ₊ᵢ₋₁ and the predicted value (expected value) of xₖ₊ⱼ is written as x′ξ′ₖ₊ⱼ, the predicted value x′ₙ₊ᵢ₋₁ can be obtained by u′ₙ₊ᵢ₋₁+ξ′ₖ₊ⱼ. This is a property that holds in common to the models that use the normal distributions, and holds when the polynomial regression is adopted for the long-term time series model.

3. Operation

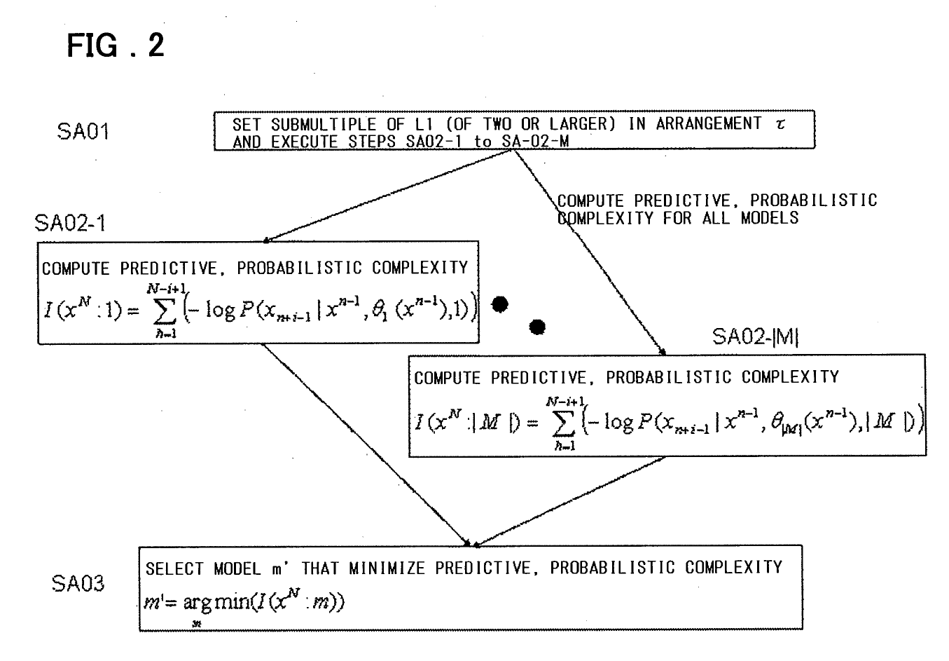

Next, a specific operation in a first embodiment will be described with reference to FIG. 1 showing a configuration of the first embodiment of the present invention, and FIGS. 2 to 4 that are flowcharts showing operations of the first embodiment will be described. In Operation for Adopting Optimal Model (1), Computation of Predictive, Probabilistic Complexities (2) is used as a module. Further, in the Computation of Predictive, Probabilistic Complexities (2), Prediction Using Model (3) is used as a module.

(1) Operation for Adopting Optimal Model

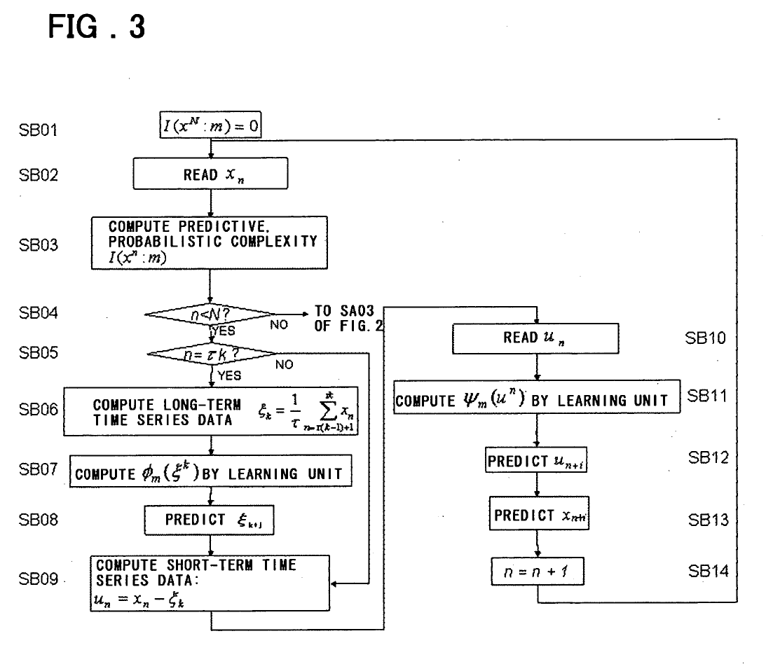

A description will be given with reference to a configuration diagram in the first embodiment of FIG. 1, and the flowchart of FIG. 2 showing a general operation in the first embodiment. Upon receipt of a command to select an optimal model for prediction of a time series from the input device 110, the optimal model selection unit 106 sets a submultiple of the cycle length L₁ of the long-term cyclic component to τ, and performs computation of the predictive, probabilistic complexities (at steps SA02-1 to SA02-|M | in FIG. 2, details of which will be described later using FIG. 3) using time series data having a predetermined time span (herein set to N) (at step SA01 in FIG. 2).

Then, the model that gives the minimum value of the predictive, probabilistic complexities I(x^{N}:m) (m=1, . . . |M|) computed is adopted as an optimal model m′ (at step SA03 in FIG. 2)

(2) Computation of Predictive, Probabilistic Complexities

Next, computation of the predictive, probabilistic complexities (detailed operation of the steps SA02-1 to SA02-|M| in FIG. 2) will be described with reference to the configuration diagram of FIG. 1 and the flowchart of FIG. 3 showing operations up to prediction using the model. Incidentally, j that will be described below is the one obtained by adding one to the integer portion of i/t.

First, the time series model learning unit 108 sets initial values to a parameter θ m=(φₘ,ψₘ) of the model stored. The long-term time series setting unit 101 reads time series data xₙ input from the input device 110 (at step SB01 in FIG. 3). The initial value of n is set to one. Then, until the value of n reaches the predetermined value N (Yes at step SB04 in FIG. 3), the following operation is repeated. First, when read data is given to the time series model learning unit 108, the device computes values of the probabilistic complexities according to a recurrence equation I(xⁿ:m)=I(xⁿ⁻¹:m)−log P(xₙ|xⁿ⁻ⁱ, θ m(xⁿ⁻ⁱ), m) based on the data and the stored parameter, for storage (at step SB03 in FIG. 3). At this point, when the value n is small so that a second term on the right side of the recurrence equation cannot be computed, a constant such as zero is employed in place of the value n. Next, the data is stored in the long-term time series storage unit 102, and the operation proceeds to step SB05 and later. When the value n exceeds the predetermined time span (n>N−1)(No at step SB04 of FIG. 3), the operation proceeds to model selection by the optimal model selection unit (at step SA03 in FIG. 2).

When n is not a multiple of τ (=τ k, k being an integer) (No at step SB05 in FIG. 3), the operation proceeds to step SB09 in FIG. 3, which will be described later. Then, when n is the multiple of τ (=τ k, k being the integer)(Yes at step SB05 in FIG. 3), the long-term time series setting unit 101 computes the long-term time series data ξₖ using Equation 13 and stores the long-term time series data ξₖ in the long-term series storage unit 102, and at the same time, gives the data to the long-term time series removing unit 103 (at step SB06 in FIG. 3). Further, the long-term time series setting unit 101 commands the time series model leaning unit 108 to perform model learning. This unit obtains a conditional probabilistic density function q(xₖ₊ⱼ|x^{k}, f(x^{k})) under a condition where the data ξₖ=(ξ₁, . . . εₖ) is obtained, using the data ξₖ (at step SB07 in FIG. 3), and predicts long-term time series data xₖ₊ⱼ after j steps (at step SB08 in FIG. 3). For prediction of the data xₖ₊ⱼ, any of various methods such as a moving average method, an exponential smoothing method, and a method of least squares can be employed, as described before. Alternatively, estimation can be performed by a method of expressing by the state space representation and performing the estimation using the Karman filter. Further, in this prediction, the estimation can be performed by a method of expressing data xₖ by the state space representation and performing the estimation using the Karman filter, for example. Then, these values are stored in the long-term time series storage unit 102. Then, removal of the long-term time series is commanded to the long-term time series removing unit 103.

The long-term time series removing unit 103 computes the short-term time series data u, using Equation 14 (at SB09 in FIG. 3). Incidentally, when computation of the data xₖ using Equation 13 has not been performed yet, the value predicted at step SB08 in FIG. 3 can be used. The original time series data and the long-term time series data that are necessary for the computation are received by referring to the long-term storage unit 102 or sequentially received from the long-term time series setting unit, and stored on a local memory or the like.

The short-term time series data uₙ computed by the long-term series removing unit 103 is given to the short-term time series setting unit 104 (at step SB10 in FIG. 3). The short-term time series setting unit 104 stores the received data uₙ in the short-term time series storage unit 105 and obtains a conditional probability density function r(uₙ₊ᵢ|uⁿ, ψ (uⁿ)) under a condition that the data uₙ is obtained, using uₙ=(u₁, . . . uₙ) (at step SB11 in FIG. 3). Short-term time series data uₙ₊ᵢ after i steps is predicted (at step SB12 in FIG. 3). Further, using Equation 11-4, the predicted value of time series data xₙ₊ᵢ is obtained (at step SB13 in FIG. 3).

After processing described above is finished, the operation proceeds to reading of the next data (to step SB02 after passing through step SB14 in FIG. 3).

(3) Predictive Operation Using Model

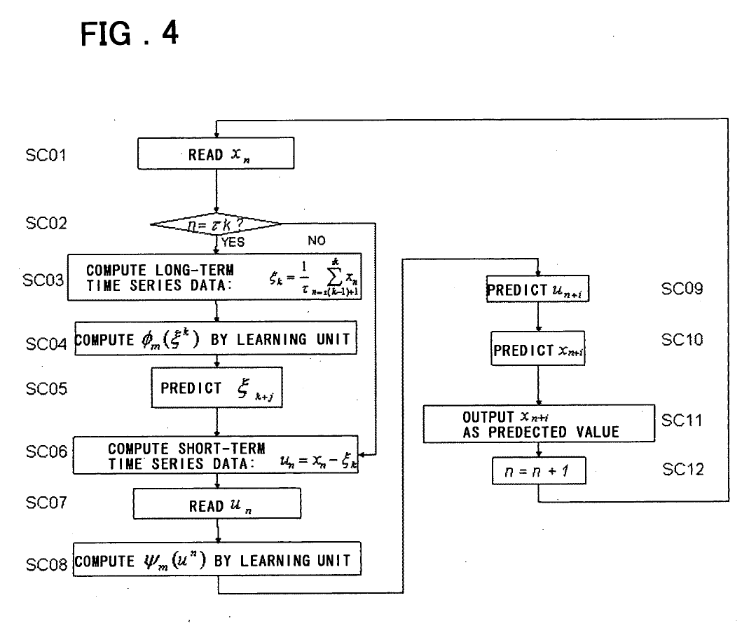

Next, prediction of time series data using the model selected in (1) will be described with reference to the configuration diagram of FIG. 1, flowchart of FIG. 3, and flowchart of FIG. 4 showing an operation of predicting a time series.

When FIGS. 3 and 4 are compared, operations in both of the drawings are substantially the same. Thus, only a difference between them will be herein described. After the data xₙ has been read at step SC01 in FIG. 4, the operation proceeds to branching to make determination whether or not the number n is a multiple of τ (at step SC02 in FIG. 4) (because there is no branching corresponding to step SB04 in FIG. 3). Steps SC03 to SC10 in FIG. 4 are the same as steps from SB06 to SB13 in FIG. 3. Then, in the predictive operation, the predicted value xₙ₊ᵢ computed by the time series prediction unit 107 is output to the output device 120 as the predicted value (at step SC11 in FIG. 4).

After processing described above is finished, the operation proceeds to reading of the next data (to step SC01 after passing through step SC12 in FIG. 4).

In this operation of predicting the time series, the model m′ selected at step SA03 shown in FIG. 2 is used as the model. The model is sequentially updated by learning, and prediction of the time series using it is performed.

The time series analysis device 100 in the description of this embodiment can also be implemented as a computer program for causing the computation unit of a computer to perform the operations described above.

4. Effects of This Embodiment

Next, effects of this embodiment will be described. In this embodiment, the long-term time series is prepared in advance, and normal time series analysis is performed on data obtained by removing this time series from the original time series data. Thus, the amount of computation can be reduced when the time series data is learned. Further, in this embodiment, the optimal model among a plurality of models when the long-term time series is prepared is selected using the optimal model selection unit. Thus, when a long-term variation is predicted, the prediction will not be influenced by a short-term variation. The prediction can be thereby performed with high accuracy.

### INDUSTRIAL APPLICABILITY

The present invention can be applied to a use such as resource management of a computer system in which a usage rate of resources (such as a CPU and a disk) in a computer system or a network system is monitored and prediction of how the usage rate will be increased in the future. Further, the present invention can also be applied to a use where a travel time (time required for passage through a certain road segment) in a traffic system is measured by a sensor, regarded as time series data, and then a variation of the time is predicted.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A time series analysis system for inputting time series data including a plurality of cyclic components, storing the time series data in a storage unit, and predicting a temporal tendency of the time series data, said time series analysis system comprising:
long-term time series setting unit of preparing long-term time series data of a different series using a plurality of time spans for each of the time spans, based on the input time series data and the time series data read from said storage unit and storing the resultant long-term time series data in said storage unit;
long-term time series removing unit of removing the long-term time series data for said each of the time spans from the input time series data, by preparing short-term time series data corresponding to the removed long-term time series data for said each of the time spans, and storing the resultant short-term time series data in said storage unit; and
optimal model selection unit of selecting a model having a time span optimal for prediction of the time series data based on learning through probability statistic processing using said long-term time series data and said short-term time series data both stored in said storage unit.

2. A time series analysis system for inputting time series data including a plurality of cyclic components, storing the time series data in a storage unit, and predicting a temporal tendency of the time series data, said time series analysis system comprising:
long-term time series setting unit of preparing from the input time series data and the time series data read from said storage unit long-term time series data of a different series as an average value for each of a plurality of time spans;
long-term time series removing unit of removing the long-term time series data for said each of the time spans from the input time series data and preparing short-term time series data corresponding to the removed long-term time series data for said each of the time spans; and
optimal model selection unit of selecting a model having a time span optimal for the prediction of the time series data based on an information amount criterion computed corresponding to said each of the time spans by probability statistic processing using the long-term time series data and the short-term time series data both stored in said storage unit.

3. The time series analysis system according to claim 1, wherein as a computation manner of the long-term time series data, one selected from the group consisting of polynomial regression model, Fourier analysis, wavelet, and base of the function space is employed.

4. A time series analysis system for inputting time series data including a plurality of cyclic components, storing the time series data in a storage unit, and predicting a temporal tendency of the time series data, said time series analysis system comprising:
long-term time series setting unit of computing long-term time series data of a different series as an average value for each of a plurality of time spans from the input time series data and the time series data read from said storage unit, learning a long-term trend component and a long-term cyclic component from the long-term time series data for said each of the time spans based on the computed long-term time series data and the long-term time series data read from said storage unit, and storing in said storage unit the input time series data, a result of the learning of a long-term time series for said each of the time spans, and the computed long-term time series data for said each of the time spans;
long-term time series removing unit of removing the long-term time series data for said each of the time spans computed by said long time series setting unit from the original time series data, thereby computing short-term time series data corresponding to said each of the time spans;
short-term time series setting unit of learning a short-term time series component from the short-term time series data for said each of the time spans based on the short-term time series data computed by the long-term time series removing unit and the short-term time series data read from said storage unit, and storing in said storage unit a result of the learning of a short-term time series for said each of the time spans and the computed short-term time series data for said each of the time spans; and
optimal model selection unit of selecting a model having a time span optimal for the prediction of the time series data based on an information amount criterion computed corresponding to said each of the time spans by probability statistic processing using the long-term time series data and the result of learning thereof and the short-term time series data and the result of learning thereof, all stored in said storage unit.

5. The time series analysis system according to claim 1, wherein for said each of the time spans for computing the long-term time series data using the different time spans, a submultiple of a cycle length of a long cycle is employed.

6. The time series analysis system according to claim 1, wherein at least one of the learning from the long-term time series data and the learning from the short-term time series data is performed using a Karman filter and an EM algorithm.

7. The time series analysis system according to claim 1, further comprising:
time series prediction unit of performing the prediction of the time series data based on said optimal model selected by said optimal model selection unit and the long-term time series data and the short-term time series data, prepared using the time span of said optimal model.

8. A time series analysis method of inputting time series data including a plurality of cyclic components, storing the time series data in a storage unit, and predicting a temporal tendency of the time series data, said time series analysis method comprising:
a long-term series setting step of preparing long-term time series data of a different series using a plurality of time spans for each of the time spans, based on the input time series data and the time series data read from said storage unit and storing the resultant long-term time series data in said storage unit;
a long-term series removing step of removing the long-term time series data for said each of the time spans from the input time series data, preparing short-term time series data corresponding to the removed long-term time series data for said each of the time spans, and storing the resultant short-term time series data in said storage unit; and
an optical model selection step of selecting a model having a time span optimal for prediction of the time series data based on learning through probability statistic processing using said long-term time series data and said short-term time series data both stored in said storage unit.

9. A time series analysis method of inputting time series data including a plurality of cyclic components, storing the time series data in a storage unit, and predicting a temporal tendency of the time series data, said time series analysis method comprising:
a long-term series setting step of preparing from the input time series data and the time series data read from said storage unit long-term time series data of a different series as an average value for each of a plurality of time spans;
a long-term series removing step of removing the long-term time series data for said each of the time spans from the input time series data and preparing short-term time series data corresponding to the removed long-term time series data for said each of the time spans; and
an optimal model selection step of selecting a model having a time span optimal for prediction of the time series data based on an information amount criterion computed corresponding to said each of the time spans by probability statistic processing using said long-term time series data and said short-term time series data both stored in said storage unit.

10. The time series analysis method according to claim 8, wherein as a computation manner of the long-term time series data, one selected from the group consisting of polynomial regression model, Fourier analysis, wavelet, and base of the function space is employed.

11. A time series analysis method of inputting time series data including a plurality of cyclic components, storing the time series data in a storage unit, and predicting a temporal tendency of the time series data, said time series analysis method comprising:
a long-term time series setting step of computing long-term time series data of a different series as an average value for each of a plurality of time spans from the input time series data and the time series data read from said storage unit, learning a long-term trend component and a long-term cyclic component from the long-term time series data for said each of the time spans based on the computed long-term time series data and the long-term time series data read from said storage unit, and storing in said storage unit the input time series data, a result of the learning of the long-term time series for said each of the time spans, and the computed long-term time series data for said each of the time spans;
a long-term time series removing step of removing the long-term time series data for said each of the time spans computed by said long time series setting unit from the original time series data, thereby computing short-term time series data corresponding to said each of the time spans;
a short-term time series setting step of learning a short-term time series component from the short-term time series data for said each time spans based on the short-term time series data computed by the long-term time series removing unit and the short-term time series data read from said storage unit, and storing in said storage unit a result of the learning of a short-term time series for said each of the time spans, and the computed short-term time series data for said each of the time spans; and
an optimal model selection step of selecting a model having a time span optimal for prediction of the time series data based on an information amount criterion computed corresponding to said each of the time spans by probability statistic processing using said long-term time series data and the result of learning thereof and said short-term time series data and the result of learning thereof, all stored in said storage unit.

12. The time series analysis method according to claim 8, wherein for said each of the time spans for computing the long-term time series data using the different time spans, a submultiple of a cycle length of a long cycle is employed.

13. The time series analysis method according to claim 8, wherein at least one of the learning from the long-term time series data and the learning from the short-term time series data is performed using a Karman filter and an EM algorithm.

14. The time series analysis method according to claim 8, further comprising:
a time series prediction step of performing prediction of the time series data based on said optimal model selected by said optimal model selection unit and the long-term time series data and the short-term time series data, prepared using the time span of said optimal model.

15. A time series analysis program for a time series analysis system for inputting time series data including a plurality of cyclic components, storing the time series data in a storage unit, and predicting a temporal tendency of the time series data, said time series analysis program causing said time series analysis system to perform the following steps comprising:
a long-term time series setting step of preparing long-term time series data of a different series using a plurality of time spans for each of the time spans, based on the input time series data and the time series data read from said storage unit and storing the prepared long-term time series data in said storage unit;
a long-term time series removing step of removing the long-term time series data for said each of the time spans from the input time series data, preparing short-term time series data corresponding to the removed long-term time series data for said each of the time spans, and storing the short-term time series data in said storage unit; and
an optimal model selection step of selecting a model having a time span optimal for prediction of the time series data based on learning through probability statistic processing using the long-term time series data and the short-term time series data both stored in said storage unit.

16. A time series analysis program for a time series analysis system for inputting time series data including a plurality of cyclic components, storing the time series data in a storage unit, and predicting a temporal tendency of the time series data, said time series analysis program causing said time series analysis system to perform the following steps comprising:
a long-term time series setting step of preparing from the input time series data and the time series data read from said storage unit long-term time series data of a different series as an average value for each of a plurality of time spans;
a long-term time series removing step of removing the long-term time series data for said each of the time spans from the input time series data and preparing short-term time series data corresponding to the removed long-term time series data for said each of the time spans; and
an optimal model selection step of selecting a model having a time span optimal for prediction of the time series data based on an information amount criterion computed corresponding to said each of the time spans by probability statistic processing using the long-term time series data and the short-term time series data both stored in said storage unit.

17. The time series analysis program according to claim 15, wherein as a computation manner of the long-term time series data, one selected from the group consisting of polynomial regression model, Fourier analysis, wavelet, or base of the function space is employed.

18. A time series analysis program for a time series analysis system for inputting time series data including a plurality of cyclic components, storing the time series data in a storage unit, and predicting a temporal tendency of the time series data, said time series analysis program causing said time series analysis system to perform the following steps comprising:
a long-term time series setting step of computing long-term time series data of a different series as an average value for each of a plurality of time spans from the input time series data and the time series data read from said storage unit, learning a long-term trend component and a long-term cyclic component from the long-term time series data for said each of the time spans based on the computed long-term time series data and the long-term time series data read from said storage unit, and storing in said storage unit the input time series data, a result of the learning of the long-term time series for said each of the time spans, and the computed long-term time series data for said each of the time spans;
a long-term time series removing step of removing the long-term time series data for said each of the time spans computed by said long time series setting unit from the original time series data, thereby computing short-term time series data corresponding to said each of the time spans;
a short-term time series setting step of learning a short-term time series component from the short-term time series data for said each of the time spans based on the short-term time series data computed by the long-term time series removing unit and the short-term time series data read from said storage unit, and storing in said storage unit a result of the learning of a short-term time series for said each of the time spans, and the computed short-term time series data for said each of the time spans; and
an optimal model selection step of selecting a model having a time span optimal for the prediction of the time series data based on an information amount criterion computed corresponding to said each of the time spans by probability statistic processing using the long-term time series data and the result of learning thereof and the short-term time series data and the result of learning thereof, all stored in said storage unit.

19. The time series analysis program according to claim 15, wherein for said each of the time spans for computing the long-term time series data using the different time spans, a submultiple of a cycle length of a long cycle is employed.

20. The time series analysis program according to claim 15, wherein at least one of the learning from the long-term time series data and the learning from the short-term time series data is performed using a Karman filter and an EM algorithm.

21. The time series analysis program according to claim 15, causing said time series analysis system to further perform the following step:
a time series prediction step of performing prediction of the time series data based on said optimal model selected by said optimal model selection unit and the long-term time series data and the short-term time series data, prepared using the time span of said optimal model.
